(19) United States
(12) Patent Application Publication
(10) Pub. No.: US 2026/0163008 A1
(43) Pub. Date: Jun. 11, 2026

(54) POSITIVE ELECTRODE SLURRY FOR RECHARGEABLE LITHIUM BATTERY, POSITIVE ELECTRODE FOR RECHARGEABLE LITHIUM BATTERY, AND RECHARGEABLE LITHIUM BATTERY INCLUDING THE SAME

(71) Applicant: SAMSUNG SDI CO., LTD., Yongin-si (KR)

(72) Inventors: Yeon A KIM, Suwon-si (KR); Sun Dae KIM, Suwon-si (KR); Eui Soo JEONG, Suwon-si (KR); Jin Hyeok LIM, Suwon-si (KR); Jin Ah SEO, Suwon-si (KR); E Rang CHO, Suwon-si (KR); Bo Mee KWON, Suwon-si (KR); Gi Hun JUNG, Suwon-si (KR); Jae Kwang KIM, Suwon-si (KR); Sang Hoon KIM, Suwon-si (KR)

(73) Assignee: SAMSUNG SDI CO., LTD., Yongin-si (KR)

(21) Appl. No.: 19/408,792

(22) Filed: Dec. 4, 2025

(30) Foreign Application Priority Data
Dec. 5, 2024 (KR) 10-2024-0179301

(51) Int. Cl. H01M 4/62; C08K 3/04; C08K 3/22; C08K 5/3472; C09D 5/24; C09D 7/61; C09D 7/63; C09D 127/16; H01M 4/131; H01M 4/525; H01M 10/052

(52) U.S. Cl. CPC H01M 4/628; C09D 5/24; C09D 7/61; C09D 7/63; C09D 127/16; H01M 4/131; H01M 4/525; H01M 4/623; H01M 4/625; H01M 10/052; C08K 3/04; C08K 2003/2293; C08K 5/3472; C08K 2201/014

(57) ABSTRACT

The present disclosure relates to a positive electrode slurry for a rechargeable lithium battery, a positive electrode for a rechargeable lithium battery, and a rechargeable lithium battery including the positive electrode. The positive slurry for a rechargeable lithium battery includes a positive electrode active material, a binder, and a positive additive.

### CROSS-REFERENCE TO RELATED APPLICATION

The present application claims priority to Korean Patent Application No. 10-2024-0179301, filed on Dec. 5, 2024 in the Korean Intellectual Property Office, the entire disclosure of which is incorporated herein by reference.

### BACKGROUND

### 1. Field of the Disclosure

The present disclosure relates to a positive electrode slurry for a rechargeable lithium battery, a positive electrode for a rechargeable lithium battery, and a rechargeable lithium battery including the positive electrode.

### 2. Discussion of Related Art

With increasing presence of electronic devices using batteries such as, e.g., mobile phones, laptop computers, electric vehicles, and the like, the demand for rechargeable batteries with high energy density and high capacity has increased. Accordingly, improving the performance of rechargeable lithium batteries may be advantageous.

A rechargeable lithium battery includes positive and negative electrodes that include active materials capable of intercalation and deintercalation of lithium ions, and an electrolyte, and produces electrical energy through oxidation and reduction reactions when the lithium ions are intercalated/deintercalated into/from the positive and negative electrodes.

### SUMMARY

One example embodiment includes a positive electrode slurry for a rechargeable lithium battery, which can implement a positive electrode for a rechargeable lithium battery, which provides resistance reduction and gas generation reduction during high voltage and high temperature storage.

One example embodiment includes a positive electrode slurry for a rechargeable lithium battery, which includes a positive electrode active material, a binder, and a positive electrode additive, wherein the positive electrode additive includes an additive of the following Chemical Formula 1:

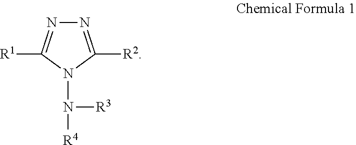

In Chemical Formula 1,
R¹, R², R³, and R⁴ are each as defined in the following description of the disclosure.

Another example embodiment includes a rechargeable lithium battery including a positive electrode formed of or including a positive electrode active material slurry, and a negative electrode including a negative electrode active material.

### BRIEF DESCRIPTION OF THE DRAWINGS

The following drawings attached to the present specification illustrate example embodiments of the present disclosure and further describe aspects and features of the present disclosure together with the detailed description of the present disclosure. Thus, the present disclosure should not be construed as being limited to the drawings, in which:

FIG. 1 is a conceptual diagram schematically showing a rechargeable lithium battery according to one example embodiment of the present disclosure.

FIG. 2 to FIG. 5 are cross-sectional views schematically showing rechargeable lithium batteries according to example embodiments.

### DETAILED DESCRIPTION

In order to fully understand the configurations and effects of the present disclosure, example embodiments of the present disclosure are described with reference to the accompanying drawings. However, it should be understood that the example embodiments disclosed below may be embodied in various forms and modified in various ways without being limited to the example embodiments described herein. The description of the present example embodiments is provided only to ensure that the disclosure of the present disclosure is complete, and to fully inform a person having ordinary skill in the art of the scope of the present disclosure.

In the present specification, when any component is referred to as being “on” another component, it means that the component may be formed directly on the other component, or a third component may be interposed therebetween. Also, in the drawings, the thicknesses of components may be exaggerated for the effective description of the technical contents. Throughout the present specification, parts denoted by the same reference numerals denote the same components.

Unless otherwise specified in the present specification, any feature indicated in the singular may also include the plural. In addition, unless otherwise particularly stated herein, “A or B” may mean “including A, including B, or including A and B.” As used in the present specification, the term “comprise” and/or “comprising” do not exclude the presence or addition of one or more other components.

In the present specification, the term “combination thereof” may refer to a mixture, laminate, composite, copolymer, alloy, blend, reaction product, and the like of components. Unless otherwise defined in the present specification, the term “substituted” means that at least one hydrogen in a substituent or compound is replaced with at least one of deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, the term “substituted” may mean that at least one hydrogen in a substituent or compound is replaced with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may mean that at least one hydrogen in a substituent or compound is replaced with deuterium, a halogen group, a C1 to C20 alkyl group, a C6 to C30 aryl group, a C1 to C10 fluoroalkyl group, or a cyano group. Alternatively, the term “substituted” may mean that at least one hydrogen in the substituent or compound is replaced with deuterium, a halogen group, a C1 to C5 alkyl group, a C6 to C18 aryl group, a C1 to C5 fluoroalkyl group, or a cyano group. As an example, the term “substituted” may mean that at least one hydrogen in the substituent or compound is replaced with deuterium, a cyano group, a halogen group, a methyl group, an ethyl group, a propyl group, a butyl group, a phenyl group, a biphenyl group, a terphenyl group, a trifluoromethyl group, or a naphthyl group.

Unless otherwise particularly defined in the present specification, the symbol “*” refers to a moiety that is connected to the same or different atom or chemical formula. Unless specifically mentioned in the chemical formulas described in the present specification, it may be seen that hydrogen is bonded in the structure of the chemical formula.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

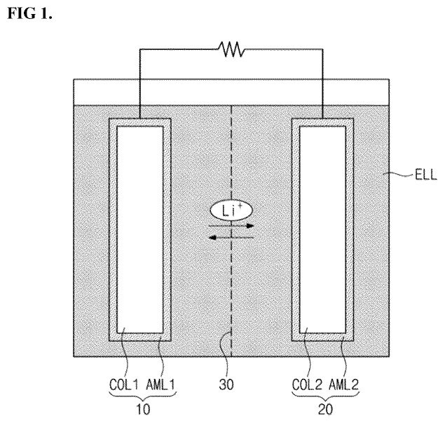

FIG. 1 is a conceptual diagram schematically showing a rechargeable lithium battery according to one example embodiment of the present disclosure. Referring to FIG. 1, the rechargeable lithium battery may include a positive electrode 10, a negative electrode 20, a separator 30, and an electrolyte (ELL).

The positive electrode 10 and the negative electrode 20 may be spaced apart from each other with the separator 30 interposed therebetween. The separator 30 may be disposed between the positive electrode 10 and the negative electrode 20. The positive electrode 10, the negative electrode 20 and the separator 30 may be in contact with the electrolyte (ELL). The positive electrode 10, the negative electrode 20 and the separator 30 may be impregnated with the electrolyte (ELL).

The electrolyte (ELL) may be or include a medium for transferring lithium ions between the positive electrode 10 and the negative electrode 20. In the electrolyte (ELL), the lithium ions may pass through the separator 30 to move toward the positive electrode 10 or the negative electrode 20.

### Positive Electrode 10

A positive electrode 10 for a rechargeable lithium battery may include a current collector (COL1) and a positive electrode active material layer (AML1) formed on the current collector (COL1). The positive electrode active material layer (AML1) includes a positive electrode active material and may further include a binder and/or a conductive material.

As an example, the positive electrode 10 may further include an additive that may constitute a sacrificial positive electrode.

The content of the positive electrode active material in the positive electrode active material layer (AML1) may range from about 90% by weight to about 99.5% by weight based on 100% by weight of the positive electrode active material layer (AML1). The contents of the binder and conductive material may each independently range from about 0.5% by weight to about 5% by weight based on 100% by weight of the positive electrode active material layer (AML1).

The binder adheres positive electrode active material particles to each other, and adheres the positive electrode active material to the current collector (COL1). Representative examples of the binder include at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but the present disclosure is not limited thereto.

The conductive material imparts conductivity to the electrodes, and any material may be used as long as the material is electronically conductive without causing adverse chemical changes in the battery to be formed. Examples of the conductive material include carbon-based materials such as at least one of natural graphite, artificial graphite, carbon black, acetylene black, Ketjen black, carbon fibers, carbon nanofibers, carbon nanotubes, and the like; metal-based materials in the form of metal powder or metal fibers containing at least one of copper, nickel, aluminum, silver, and the like; conductive polymers such as polyphenylene derivatives and the like; or a mixture thereof.

Al may be used as the current collector (COL1), but the present disclosure is not limited thereto.

### Positive Electrode Active Material

As the positive electrode active material in the positive electrode active material layer (AML1), a compound capable of reversible intercalation and deintercalation of lithium (lithiated intercalation compound) may be used. For example, at least one of a composite oxide of lithium and a metal such as or including at least one of cobalt, manganese, nickel, and a combination thereof may be used.

The composite oxide may be or include a lithium transition metal composite oxide, and examples thereof include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0<b≤0.5, 0<c≤0.05); LiₐNi_{1-b-c}CO_{b}X_{c}O_{2-α}D_{α} (0.90≤a≤1.8, 0≤ b≤0.5, 0≤c≤0.5, 0<α<2); LiₐNi_{1-b-c}Mn_{b}X_{c}O_{2-α}D_{α} (0.90<a>1.8, 0≤b><0.5, 0<<<0.5, 0<α<2); LiₐNi_{b}Co_{c}L_{d}¹GₑO₂ (0.90<a><1.8, 0<b>1 0.9, 0<<<0.5, 0<d<0.5, 0<<<0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn2G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

As an example, the positive electrode active material may be or include a high-nickel positive electrode active material in which the content of nickel is in a range of about 80 mol % or more, about 85 mol % or more, about 90 mol % or more, about 91 mol % or more, or about 94 mol % or more, and about 99 mol % or less, based on 100 mol % of metals excluding lithium in the lithium transition metal composite oxide. The high-nickel positive electrode active material may achieve high capacity, and thus may be applied to high-capacity, high-density rechargeable lithium batteries.

### Negative Electrode 20

A negative electrode 20 for a rechargeable lithium battery includes a current collector (COL2) and a negative electrode active material layer (AML2) disposed on the current collector (COL2). The negative electrode active material layer (AML2) includes a negative electrode active material, and may further include a binder and/or a conductive material.

For example, the negative electrode active material layer (AML2) may include a range of about 90% by weight to about 99% by weight of the negative electrode active material, a range of about 0.5% by weight to about 5% by weight of the binder, and a range of about 0% by weight to about 5% by weight of the conductive material.

The binder adheres negative electrode active material particles to each other, and adheres the negative electrode active material to the current collector (COL2). A non-aqueous binder, an aqueous binder, a dry binder, or a combination thereof may be used as the binder.

The non-aqueous binder includes at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose-based compound capable of imparting viscosity. As the cellulose-based compound, one or more types of carboxymethyl cellulose, hydroxypropylmethyl cellulose, methyl cellulose, or alkali metal salts thereof may be mixed and used. At least one of Na, K or Li may be used as the alkali metal.

The dry binder is or includes a fiberizable polymeric material, and may be or include, for example, at least one of polytetrafluoroethylene, polyvinylidene fluoride, a polyvinylidene fluoride-hexafluoropropylene copolymer, polyethylene oxide, or a combination thereof.

The conductive material imparts conductivity to the electrodes, and any material may be used as long as the material is electronically conductive without causing adverse chemical changes in the battery to be formed. Examples include carbon-based materials such as at least one of natural graphite, artificial graphite, carbon black, acetylene black, Ketjen black, carbon fibers, carbon nanofibers, carbon nanotubes, and the like; metal-based materials in the form of metal powder or metal fibers containing at least one of copper, nickel, aluminum, silver, and the like; conductive polymers such as polyphenylene derivatives and the like; or a mixture thereof.

A current collector such as or including at least one of copper foil, nickel foil, stainless steel foil, titanium foil, a nickel foam, a copper foam, a polymer substrate coated with a conductive metal, and a combination thereof, may be used as the current collector (COL2).

### Negative Electrode Active Material

The negative electrode active material in the negative electrode active material layer (AML2) includes at least one of a material capable of reversible intercalation/deintercalation of lithium ions, a lithium metal, an alloy of lithium and a metal, a material capable of doping and dedoping lithium, or a transition metal oxide.

The material capable of reversible intercalation/deintercalation of lithium ions may include a carbon-based negative electrode active material, for example, crystalline carbon, amorphous carbon, or a combination thereof. Examples of the crystalline carbon include graphite such as amorphous, plate-like, flaky, spherical, or fibrous natural or artificial graphite. Examples of the amorphous carbon include at least one of soft carbon or hard carbon, mesophase pitch carbide, calcined coke, and the like.

As the alloy of lithium and a metal, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or a Sn-based negative electrode active material may be used. The Si-based negative electrode active material may be or include at least one of silicon, a silicon-carbon composite, SiOₓ (0<x<2), a Si-Q alloy (wherein Q is or includes at least one of an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to one example embodiment, the silicon-carbon composite may be in the form of silicon particles which surfaces are coated with amorphous carbon. For example, the silicon-carbon composite may include a secondary particle (core) in which silicon primary particles are assembled, and an amorphous carbon coating layer (shell) disposed on the surface of the secondary particle. The amorphous carbon may also be located between the silicon primary particles, and for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer disposed on the surface of the core.

The Si-based negative electrode active material or the Sn-based negative electrode active material may be used in combination with a carbon-based negative electrode active material.

### Separator 30

A separator 30 may be present between the positive electrode 10 and the negative electrode 20 depending on the type of rechargeable lithium battery. As the separator 30, at least one of polyethylene, polypropylene, polyvinylidene fluoride, or a multi-layer film of two or more layers thereof may be used. A mixed multi-layer film such as a polyethylene/polypropylene two-layer separator, a polyethylene/polypropylene/polyethylene three-layer separator, a polypropylene/polyethylene/polypropylene three-layer separator, and the like may also be used.

The separator 30 may include a porous substrate and a coating layer including an organic material, an inorganic material, or a combination thereof, and disposed on one or both surfaces of the porous substrate.

The porous substrate may be or include a polymer film formed of or including any one polymer such as or including at least one of polyolefins such as polyethylene, polypropylene, and the like, polyesters such as polyethylene terephthalate, polybutylene terephthalate, polyethylene naphthalate and the like, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, glass fibers, Teflon, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic and inorganic materials may be present as a mixture in one coating layer, or may be present in a form in which a coating layer including an organic material and a coating layer including an inorganic material are laminated.

### Electrolyte (ELL)

An electrolyte (ELL) for a rechargeable lithium battery includes a non-aqueous organic solvent and a lithium salt.

The non-aqueous organic solvent constitutes a medium through which ions involved in the electrochemical reaction of the battery may move.

The non-aqueous organic solvent may be or include at least one of a carbonate-based, ester-based, ether-based, ketone-based, or alcohol-based solvent, an aprotic solvent, or a combination thereof.

As the carbonate-based solvent, at least one of dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), and the like may be used.

As the ester-based solvent, at least one of methyl acetate, ethyl acetate, n-propyl acetate, dimethyl acetate, methyl propionate, ethyl propionate, decanolide, mevalonolactone, valerolactone, caprolactone, and the like may be used.

As the ether-based solvent, at least one of dibutyl ether, tetraglyme, diglyme, dimethoxyethane, 2-methyltetrahydrofuran, 2,5-dimethyltetrahydrofuran, tetrahydrofuran, and the like may be used. Also, cyclohexanone and the like may be used as the ketone-based solvent. Ethyl alcohol, isopropyl alcohol, and the like may be used as the alcohol-based solvent. As the aprotic solvent, at least one of nitriles such as R-CN(where R is a linear, branched, or cyclic hydrocarbon group having 2 to 20 carbon atoms and may include a double bond, an aromatic ring, or an ether group) and the like; amides such as dimethylformamide and the like; dioxolanes such as 1,3-dioxolane, 1,4-dioxolane, and the like; and sulfolanes may be used.

The non-aqueous organic solvents may be used alone, or in combination of two or more solvents.

When the carbonate-based solvent is used, a cyclic carbonate and a chain carbonate may be used in combination, and the cyclic carbonate and the chain carbonate may be mixed in a volume ratio in a range of about 1:1 to about 1:9.

The lithium salt dissolves in a non-aqueous organic solvent and thus constitutes a source of lithium ions in the battery, thereby allowing the basic operation of a rechargeable lithium battery, and promotes the movement of lithium ions between the positive and negative electrodes. Representative examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N(lithium bis(fluorosulfonyl)imide (LiFSI), LiC₄F₉SO₃, LiN(CₓF₂ₓ₊₁SO₂)(C_{y}F_{2y+1}SO₂) (where x and y are integers in a range from 1 to 20), lithium trifluoromethane sulfonate, lithium tetrafluoroethanesulfonate, lithium difluorobis(oxalato) borate (LiDFOB), lithium difluorobis(oxalato)phosphate (LiDFBOP), and lithium bis(oxalato) borate (LiBOB), lithium bis(trifluoromethanesulfonyl)imide (LiTFSI) and lithium tetrafluoro (oxalato)phosphate (LiTFOP).

### Rechargeable Lithium Battery

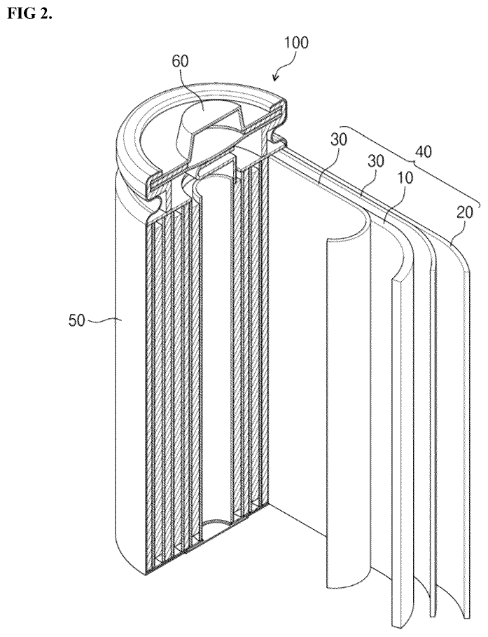

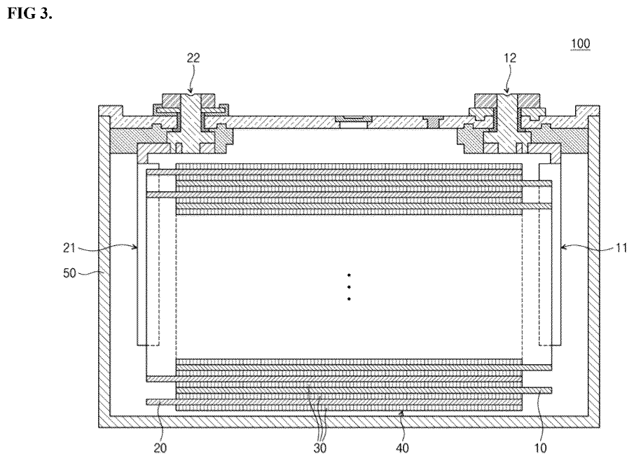

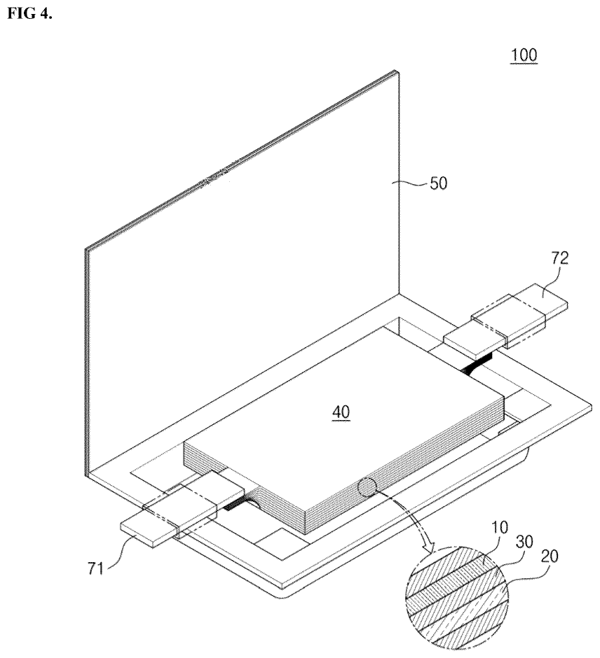

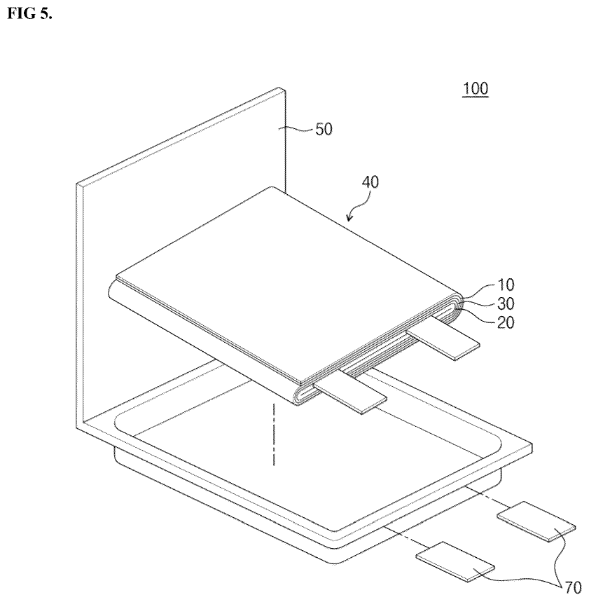

Rechargeable lithium batteries may be classified into cylindrical, prismatic, pouch-type, and coin-type rechargeable lithium batteries depending on the type of rechargeable lithium battery. FIG. 2 to FIG. 5 are diagrams schematically showing rechargeable lithium batteries according to example embodiments. The rechargeable lithium batteries can be said to be cylindrical, prismatic, and pouch-type batteries, as shown in FIG. 2, FIG. 3, FIG. 4 and FIG. 5, respectively. Referring to FIG. 2 to FIG. 5, a rechargeable lithium battery 100 may include an electrode assembly 40 having a separator 30 interposed between a positive electrode 10 and a negative electrode 20, and a case 50 in which the electrode assembly 40 is built. The positive electrode 10, the negative electrode 20, and the separator 30 may be impregnated with an electrolyte (not shown). The rechargeable lithium battery 100 may include a sealing member 60 configured to seal the case 50 as shown in FIG. 2. As shown in FIG. 3, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 4 and FIG. 5, the rechargeable lithium battery 100 may include electrode tabs 70 illustrated in FIG. 5, or a positive electrode tab 71 and a negative electrode tab 72 illustrated in FIG. 4, the electrode tabs 70/71/72 forming electric paths configured to conduct current formed in the electrode assembly 40 to the outside of the battery 100.

Hereinafter, a positive electrode slurry for a rechargeable lithium battery according to example embodiments of the present disclosure is described in more detail.

The positive electrode slurry for a rechargeable lithium battery includes a positive electrode active material, a binder, and a positive electrode additive, in which the positive electrode additive includes an additive of the following Chemical Formula 1.

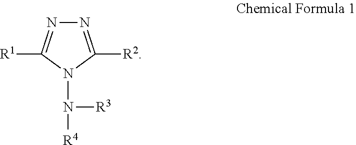

In Chemical Formula 1,
R¹ and R² each independently is or includes hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group,
R³ and R⁴ each independently is or includes hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, a substituted or unsubstituted C2 to C20 heteroaryl group, or the following Chemical Formula 1-1, and
at least one of R³ and R⁴ is represented by the following Chemical Formula 1-1.

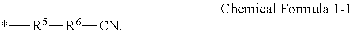

In Chemical Formula 1-1,
R⁵ and R⁶ each independently is or includes a single bond, a substituted or unsubstituted C1 to C20 alkylene group, a substituted or unsubstituted C1 to C20 alkoxylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C6 to C20 arylene group, or a substituted or unsubstituted C2 to C20 heteroarylene group.

The additive of Chemical Formula 1 may provide a positive electrode that provides a low gas generation rate, a low resistance increase rate, and a high open-circuit voltage (OCV) retention rate after high voltage and high temperature storage. These properties are due to the fact that the additive of Chemical Formula 1 forms a substantially uniform and stable film on a surface of the positive electrode during activation and operation of the rechargeable battery, but the present disclosure is not limited thereto.

When applied to a positive electrode slurry including a positive electrode active material with a high nickel content, the additive of Chemical Formula 1 may provide a positive electrode that provides a low gas generation rate, a low resistance increase rate, and a high OCV retention rate even during high voltage and high temperature storage without affecting a high energy density of the positive electrode active material.

In an example, both R³ and R⁴ in Chemical Formula 1 may be or include the compound of Chemical Formula 1-1. In this case, the compound of Chemical Formula 1 can have the desired or improved effects of providing a low gas generation rate, a low resistance increase rate, and a high OCV retention rate during high voltage and high temperature storage in the positive electrode slurry including the positive electrode active material with a high nickel content.

In an example, in Chemical Formula 1-1, R⁵ and R⁶ may each independently be or include a substituted or unsubstituted C1 to C20 alkylene group, for example, a substituted or unsubstituted C1 to C10 alkylene group, or a substituted or unsubstituted C1 to C5 alkylene group, for example, a methylene, ethylene, linear or branched propylene, linear or branched butylene, or linear or branched pentylene group. In this case, the compound of Chemical Formula 1 can have the desired or improved effects of providing a low gas generation rate, a low resistance increase rate, and a high OCV retention rate during high voltage and high temperature storage in the positive electrode slurry including the positive electrode active material with a high nickel content.

R¹ and R² may each independently be or include hydrogen, a substituted or unsubstituted C1 to C20 alkyl group, for example, a substituted or unsubstituted C1 to C10 alkyl group, or a substituted or unsubstituted C1 to C5 alkyl group, for example, hydrogen, methyl, ethyl, linear or branched propyl, linear or branched butyl, or linear or branched pentyl. In this case, the compound of Chemical Formula 1 can have the desired or improved effects of providing a low gas generation rate, a low resistance increase rate, and a high OCV retention rate in the positive electrode slurry including the positive electrode active material with a high nickel content.

The compound of Chemical Formula 1 according to another example embodiment of the present disclosure may be or include one or more compounds of the following Chemical Formulas 1 to 3.

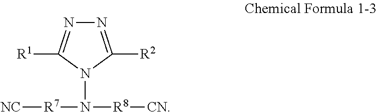

In Chemical Formula 1-3,
R¹ and R² are, each independently, as defined in Chemical Formula 1,
R⁷ and R⁸ each independently is or includes a substituted or unsubstituted C1 to C20 alkylene group, a substituted or unsubstituted C1 to C20 alkoxylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C6 to C20 arylene group, or a substituted or unsubstituted C2 to C20 heteroarylene group.

In an example, in Chemical Formulas 1 to 3, R⁷ and R⁸ may each independently be or include a substituted or unsubstituted C1 to C20 alkylene group, for example, a substituted or unsubstituted C1 to C10 alkylene group, or a substituted or unsubstituted C1 to C5 alkylene group, for example, a methylene, ethylene, linear or branched propylene, linear or branched butylene, or linear or branched pentylene group. In this case, when applied to the positive electrode slurry including the positive electrode active material with a high nickel content, the compound of Chemical Formula 1 may have the desired or improved effect of providing a low gas generation rate, a low resistance increase rate, and a high OCV retention rate. In an example embodiment, the compound of Chemical Formula 1 may include one or more of the following Chemical Formulas 1˜4 to 1-10.

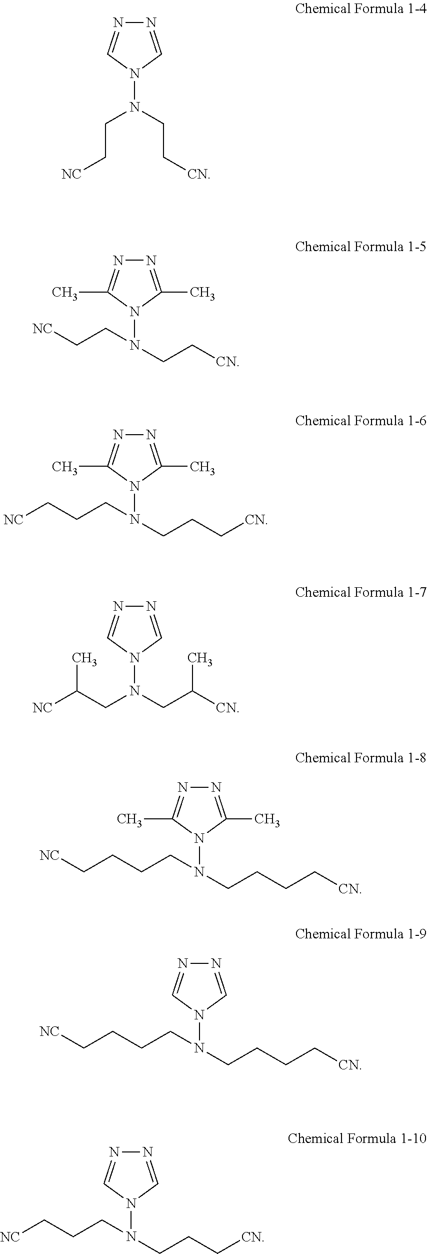

The compound of Chemical Formula 1 and the compound of Chemical Formula 1-3 may be synthesized through conventional synthetic methods known to those skilled in the art. For example, the compound may be prepared using a compound that provides 4H-1,2,4-triazole and a CN group.

The additive of Chemical Formula 1 may be included in an amount in a range of about 0.1 parts by weight to about 10 parts by weight based on 100 parts by weight of a positive electrode active material. The content of the additive of Chemical Formula 1 may be the content of the additive of Chemical Formula 1 in the positive electrode slurry based on 100 parts by weight of the total weight of the positive electrode active material in the positive electrode slurry. In the above content range, a positive electrode that provides a low resistance increase rate and a low gas generation rate during high voltage and high temperature storage may be provided. For example, the additive of Chemical Formula 1 may be included in an amount in a range of about 0.1 parts by weight to about 5 parts by weight, 0.1 parts by weight to 3 parts by weight, or 0.1 parts by weight to 1 part by weight based on 100 parts by weight of the positive electrode active material.

The positive electrode slurry may include the above lithium transition metal composite oxide as the positive electrode active material. That is, the positive electrode slurry may include at least one of a lithium nickel-based oxide, a lithium cobalt-based oxide, a lithium manganese-based oxide, a lithium iron phosphate-based oxide, a cobalt-free nickel manganese-based oxide, or a combination thereof as the positive electrode active material.

In an example, the positive electrode slurry may include a lithium nickel-based oxide. For example, the lithium nickel-based oxide may be represented by the following Chemical Formula 2.

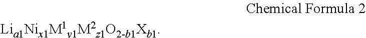

In Chemical Formula 2, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² each independently is or includes one or more of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 2, 0.6≤x1≤1, 0≤y1≤0.4, and 0≤z1≤0.4, or 0.8≤x1≤1, 0≤y1≤0.2, and 0≤z1≤0.2.

For example, the positive electrode active material may be or include a high nickel-based lithium nickel-based oxide in which the nickel content is in a range of about 80 mol % or more, about 85 mol % or more, about 90 mol % or more, about 91 mol % or more, or about 99 mol % or less based on 100 mol % of metals excluding lithium from the lithium nickel-based oxide. The high nickel-based lithium nickel-based oxide may exhibit a high capacity, thereby providing a rechargeable lithium battery with a high capacity and a high energy density.

In an example, the lithium nickel-based oxide may be included in a range of about 95 wt % or more, for example, a range of about 95 wt % to about 100 wt %, 99 wt % to 100 wt %, or 100 wt % of the positive electrode active material.

The binder may include one or more of the binders described for the above positive electrode.

In an example, the binder may include a fluorine-based binder. For example, the fluorine-based binder may include a fluorine-substituted hydrocarbon resin. For example, the fluorine-substituted hydrocarbon resin may include at least one of polyvinylidene fluoride (PVDF), vinylidene fluoride-hexafluoropropylene copolymer (PVDF-co-HFP), and the like.

The positive electrode slurry may further include a conductive material.

The conductive material may include one or more of the conductive materials described for the above positive electrode.

In an example, the conductive material may include one or more of artificial graphite and carbon black.

The positive electrode active material, conductive material, and binder that are included in the positive electrode slurry may include a range of about 90 parts by weight to about 99 parts by weight of the positive electrode active material, a range of about 0.5 parts by weight to about 5 parts by weight of the conductive material, and a range of about 0.5 parts by weight to about 5 parts by weight of the binder based on the total of 100 parts by weight.

The positive electrode slurry may further include a dispersion medium.

The dispersion medium may include a polar organic solvent such as N-methyl-2-pyrrolidone or the like.

The dispersion medium may be included in an amount a range of about 15 wt % to about 30 wt % of the positive electrode slurry.

The solid content of the positive electrode slurry may range from about 70 wt % to 85 about wt %.

The viscosity of the positive electrode slurry may range from about 1,000 cP to about For example, the viscosity of the positive electrode slurry may range from 1,000 10,000 cP. 1,000 cP to 5,000 cP or from 2,000 cP to 4,000 cP. By controlling the amount of dispersion medium added during the manufacturing of the positive electrode slurry, the slurry may be prepared to satisfy the viscosity range. When the positive electrode slurry satisfies the viscosity range, the positive electrode stabilizing effect of the positive electrode additive can be improved or maximized.

When the viscosity of the positive electrode slurry is within the above range, a challenge of the slurry being lost when a positive electrode current collector is coated with the slurry may not occur, and a challenge of an excessive amount of slurry being applied and the positive electrode active material layer becoming thick may not occur.

The viscosity of the positive electrode slurry may be measured at room temperature (25° C.) using, e.g., a B-type viscometer. However, a viscosity measuring device is not limited to the above description, and any device capable of measuring the viscosity of a liquid may be used without limitation.

A method of preparing a positive electrode slurry may be performed by an operation of mixing a positive electrode active material, a binder, a conductive material, and the compound of Chemical Formula 1 as a positive electrode additive.

Hereinafter, a positive electrode for a rechargeable lithium battery according to example embodiments of the present disclosure is described in more detail.

The positive electrode may include a positive electrode active material layer manufactured using the positive electrode slurry.

The positive electrode may be manufactured by an operation of preparing a positive electrode slurry and an operation of coating a current collector with the positive electrode slurry and forming a positive electrode active material layer.

In another example embodiment of the present disclosure, the rechargeable lithium battery may include a positive electrode including a positive electrode active material, and a negative electrode including a negative electrode active material, in which the positive electrode may include a positive electrode manufactured from the positive electrode slurry.

The rechargeable lithium battery may be applicable to, e.g., vehicles, mobile phones, and/or various types of electrical devices, and the present disclosure is not limited thereto.

Since the positive electrode has been described above, the detailed descriptions of the positive electrode slurry and the positive electrode are omitted.

In an example embodiment, the negative electrode active material may contain at least one of graphite and a Si composite.

When the negative electrode active material contains a Si composite and graphite together, the Si composite and the graphite may be contained in the form of a mixture, and in this case, the Si composite and the graphite may be contained in a weight ratio in a range of about 1:99 to about 50:50 based on a total of 100 parts by weight. For example, the Si composite and the graphite may be contained in a weight ratio in a range of about 3:97 to about 20:80, a range of about 4:96 to about 20:80, or a range of about 5:95 to about 20:80.

The Si composite includes a core including Si-based particles and an amorphous carbon coating layer, and for example, the Si-based particles may include one or more of a Si—C composite, SiOₓ (0<x≤2), and a Si alloy. For example, the Si—C composite may include a core including Si particles and crystalline carbon, and an amorphous carbon coating layer located on a surface of the core. The crystalline carbon may include, for example, graphite, and for example, include natural graphite, artificial graphite, or a mixture thereof.

The rechargeable lithium battery may further include an electrolyte.

The electrolyte includes the non-aqueous organic solvent, and a lithium salt.

The non-aqueous organic solvent may include one or more of the above non-aqueous organic solvents.

In one example, the non-aqueous organic solvent may be or include a mixture containing ethylene carbonate (EC): ethyl methyl carbonate (EMC): dimethyl carbonate (DMC) in a volume ratio in a range of about 10 to 30:10 to 30:40 to 80. Here, the volume ratio is a value based on a total of 100% by volume of ethylene carbonate (EC): ethyl methyl carbonate (EMC): dimethyl carbonate (DMC). In the above range, it is possible to implement the effect of the additive to be described below, and the life of the battery can be further increased under high voltage and high temperature conditions in a rechargeable lithium battery including a positive electrode active material with a high nickel content, which is described below.

The lithium salt according to one example embodiment of the present disclosure may include one or more of LiPF₆, LiClO₄, LiBF₄, lithium bis(fluorosulfonyl)imide (LiFSI), lithium bis(trifluoromethanesulfonyl)imide (LiTFSI), LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LiN(SO₃C₂F₅)₂, Li(FSO₂)₂N, and LiC₄F₉SO₃. According to one example embodiment, LiPF₆ may be used as the lithium salt.

The concentration of the lithium salt may range from about 0.1 M to about 3.0 M. For example, the concentration of the lithium salt may be about 0.5 M or more, and may be about 1.0 M or more. The concentration of the lithium salt may be about 3.0 M or less, about 2.5 M or less, or about 2.0 M or less. In the present disclosure, when the concentration of the lithium salt ranges from about 0.1 M to about 2.0 M, the conductivity of the electrolyte and the viscosity of the electrolyte can be maintained as desired.

Hereinafter, examples and comparative examples of the present disclosure are described. However, the following examples are merely one example embodiment of the present disclosure, and the present disclosure is not limited to the following examples.

### Examples and Comparative Examples

### Example 1

### (1) Preparation of Additive for Positive Electrode Slurry

8 g of NaOH is added to a rounded bottom flask, 50 g of distilled water is added, and the mixture is stirred at room temperature (23±2° C.) for 30 minutes.

8.41 g of 4-amino-1,2,4-triazole is added to the mixture and stirred for an additional 30 minutes, and then 13.3 g of acrylonitrile is slowly added dropwise to a reactant while keeping the internal temperature of the reactant from exceeding 40° C.

When a white solid is generated, the white solid is filtered through a filter and washed with water and ethanol, and then vacuum-dried to obtain compounds of the following Chemical Formula 1-4 ((400 MHz, DMSO-d₆): δ 8.74 (s, 2H), 3.40-3.37 (m, 4H), 2.53-2.49 (m, 4H)).

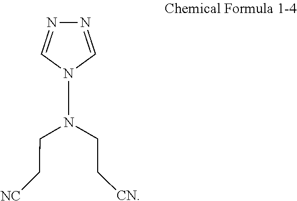 [SMILES: N#CCCN(CCC#N)n1cnnc1]

### (2) Preparation of Positive Electrode Slurry

A positive electrode slurry was prepared by mixing 97.5 wt % of LiNi_{0.91}Co_{0.08}Al_{0.01}O₂, 0.5 wt % of artificial graphite powder, 1 wt % of carbon black (Ketjen black), and 1 wt % of polyvinylidene fluoride (PVdF), mixing 0.5 parts by weight of the compounds of Chemical Formula 1-4 based on 100 parts by weight of the positive electrode active material, adding the mixture to N-methyl-2-pyrrolidone (NMP), and stirring the mixture for 30 minutes using a mechanical stirrer.

### (3) Manufacturing of Rechargeable Lithium Battery

A positive electrode was manufactured by coating an aluminum current collector having a thickness of 20 μm with the slurry to a thickness of 60 μm using a doctor blade, drying the aluminum current collector in a hot air dryer at 100° C. for 0.5 hours, re-drying the aluminum current collector under vacuum at 120° C. for 4 hours, and roll-pressing the aluminum current collector.

A negative electrode active material slurry was prepared by mixing 98 wt % of a negative active material containing graphite and a Si composite mixed in a weight ratio of 95.8:4.2, 1 wt % of styrene-butadiene rubber (SBR), and 1 wt % of carboxymethyl cellulose (CMC), adding the mixture to distilled water, and stirring the mixture for 60 minutes using a mechanical stirrer. A negative electrode was manufactured by coating a copper current collector having a thickness of 10 μm with the slurry to a thickness of 60 μm using a doctor blade, drying the copper current collector in a hot air dryer at 100° C. for 0.5 hours, re-drying the copper current collector under vacuum at 120° C. for 4 hours, and roll-pressing the copper current collector.

A cylindrical rechargeable lithium battery was manufactured by assembling the positive electrode, the negative electrode, and a separator formed of or including polyethylene having a thickness of 16 μm to manufacture an electrode assembly and injecting an electrolyte into the electrode assembly. The electrolyte was prepared by dissolving and mixing 1.25 M of LiPF₆ in a carbonate-based solvent containing ethylene carbonate (EC): ethyl methyl carbonate (EMC): dimethyl carbonate (DMC) mixed in a ratio of 20:30:50 (volume ratio).

### Example 2

A positive electrode slurry and a battery were manufactured by the same method as in Example 1, except that the content of the compound of Chemical Formula 1-4 was included in an amount of 1 part by weight based on 100 parts by weight of the positive electrode active material in Example 1.

### Example 3

A positive electrode slurry and a battery were manufactured by the same method as in Example 1, except that the content of the compound of Chemical Formula 1-4 was included in an amount of 2 parts by weight based on 100 parts by weight of the positive electrode active material in Example 1.

### Example 4

A positive electrode slurry and a battery were manufactured by the same method as in Example 1, except that the content of the compound of Chemical Formula 1-4 was included in an amount of 5 parts by weight based on 100 parts by weight of the positive electrode active material in Example 1.

### Comparative Example 1

A positive electrode slurry and a battery were manufactured by the same method as in Example 1, except that the compound of Chemical Formula 1-4 in Example 1 was not contained.

### Evaluation Examples

A rechargeable lithium battery was evaluated by the following method.

### Evaluation Example 1: High-Temperature Storage Characteristic Evaluation (Cell Thickness Increase Rate)

For rechargeable lithium batteries according to the examples and comparative examples, a cell thickness increase rate was measured to evaluate high-temperature gas generation characteristics. A thickness of the initial cell battery and a thickness of the cell battery after storage at 60° C. for 28 days were measured, and the thickness increase rate was calculated. The thickness increase rate was calculated according to the following equation.

### Equation:

Thickness increase rate (%)=[(thickness of cell battery after storage at 60° C. for 28days)/(initial thickness of cell battery)]*100.

Specifically, the thickness of the cell battery was measured using a Mitutoyo compression-type thickness measuring device in a state in which a pouch cell was located between compression plates and compressed with a weight of 300 g.

### Evaluation Example 2: High-Temperature Storage Characteristic Evaluation (OCV Retention Rate)

For the rechargeable lithium batteries according to the examples and comparative examples, OCVs were measured after charging at 0.5 C/4.4 V 0.05 C cut-off, the OCVs were measured after storage at 60° C. for 28 days, and a delta OCV (ΔOCV) was calculated therefrom. A small ΔOCV value means that the capacity retention rate is desired or improved.

### Evaluation Example 3: High-Temperature Storage Characteristic Evaluation (DCIR Increase Rate)

For rechargeable lithium batteries according to the examples and comparative examples, initial direct current resistance (DCIR) was measured as a AV/AI (change in voltage/change in current) value, and then a maximum energy state inside the battery was made into a fully charged state (SOC 100%), and in this state, the battery was stored at 60° C. for 60 days, and then DC resistance was measured, and the DCIR increase rate (%) was calculated according to the following equation.

### Equation:

DCIR Increase rate (%)=(DCIR after 60 days/initial DCIR)*100.

The results of Evaluation Examples 1 to 3 are shown in Table 1 below.

TABLE 1

| | | | Thickness of | | | | | | | |
|---|---|---|---|---|---|---|---|---|---|---|
| | | | cell battery | | | | | DCIR | | |
| | | | 0 | 28 | Increase | OCV (V) | | 0 | 60 | Increase |
| | Additive | | days | days | rate | 0 | 28 | days | days | rate |
| | Type | Content* | (cm) | (cm) | (%) | days | days | (mΩ) | (mΩ) | (%) |
| Exam- | Chemical | 0.5 | 10.26 | 14.69 | 143.2 | 4.23 | 4.11 | 8.89 | 10.87 | 122.3 |
| ple 1 | Formula | | | | | | | | | |
| | 1-4 | | | | | | | | | |
| Exam- | Chemical | 1 | 10.26 | 14.55 | 141.8 | 4.23 | 4.11 | 8.97 | 10.98 | 122.4 |
| ple 2 | Formula | | | | | | | | | |
| | 1-4 | | | | | | | | | |
| Exam- | Chemical | 2 | 10.27 | 14.12 | 137.5 | 4.23 | 4.13 | 9.23 | 11.35 | 123.0 |
| ple 3 | Formula | | | | | | | | | |
| | 1-4 | | | | | | | | | |
| Exam- | Chemical | 5 | 10.27 | 13.59 | 132.3 | 4.23 | 4.14 | 9.45 | 11.67 | 123.5 |
| ple 4 | Formula | | | | | | | | | |
| | 1-4 | | | | | | | | | |
| Compar- | — | — | 10.33 | 15.12 | 146.4 | 4.23 | 4.09 | 8.51 | 10.54 | 123.9 |
| ative | | | | | | | | | | |
| Exam- | | | | | | | | | | |
| ple 1 | | | | | | | | | | |

*in Table 1, Content*: content of compound based on 100 parts by weight of positive electrode active material

### SUMMARY

Referring to Table 1, it can be concluded that the rechargeable lithium batteries having the positive electrode manufactured with the positive slurry of the examples can improve the life and performance at high temperatures even when including a high-nickel-based positive electrode active material based on the results of Evaluation Examples 1 to 3.

However, referring to Table 1, in Comparative Example 1 which does not include the compound of Chemical Formula 1 of the present disclosure, the effect of improving the life and performance at high temperatures even when the rechargeable lithium battery included the high-nickel positive electrode active material was insignificant based on the results of Evaluation Examples 1 to 3.

In the positive electrode slurry for a rechargeable lithium battery according to one example embodiment, by providing a positive electrode having a low gas generation rate, a low resistance increase rate, and a high open-circuit voltage (OCV) retention rate when the rechargeable lithium battery is activated during high voltage and high temperature storage, it is possible to improve the life characteristics and stability of the rechargeable lithium battery.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A positive electrode slurry for a rechargeable lithium electrode, the positive electrode slurry comprising:
a positive electrode active material;
a binder; and
a positive electrode additive,
wherein the positive electrode additive includes a compound of Chemical Formula 1: 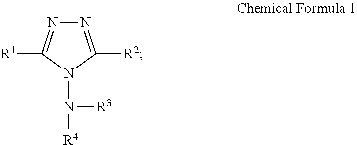
wherein:
R¹ and R² each independently comprises hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group,
R³ and R⁴ each independently comprises hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, a substituted or unsubstituted C2 to C20 heteroaryl group, or Chemical Formula 1-1, and
at least one of R³ and R⁴ comprises Chemical Formula 1-1: 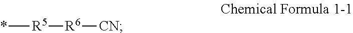
wherein:
R⁵ and R⁶ each independently comprises a single bond, a substituted or unsubstituted C1 to C20 alkylene group, a substituted or unsubstituted C1 to C20 alkoxylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C6 to C20 arylene group, or a substituted or unsubstituted C2 to C20 heteroarylene group.

2. The positive electrode slurry of claim 1, wherein the additive of Chemical Formula 1 is represented by Chemical Formula 1-3: 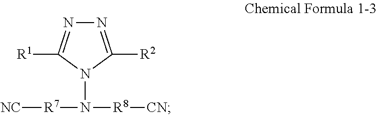
wherein:
R¹ and R² are, each independently, as defined as in Chemical Formula 1, and
R⁷ and R⁸ each independently comprises a substituted or unsubstituted C1 to C20 alkylene group, a substituted or unsubstituted C1 to C20 alkoxylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C6 to C20 arylene group, or a substituted or unsubstituted C2 to C20 heteroarylene group.

3. The positive electrode slurry of claim 1, wherein the additive of Chemical Formula 1 includes one or more of Chemical Formulas 1˜4 to 1-10:

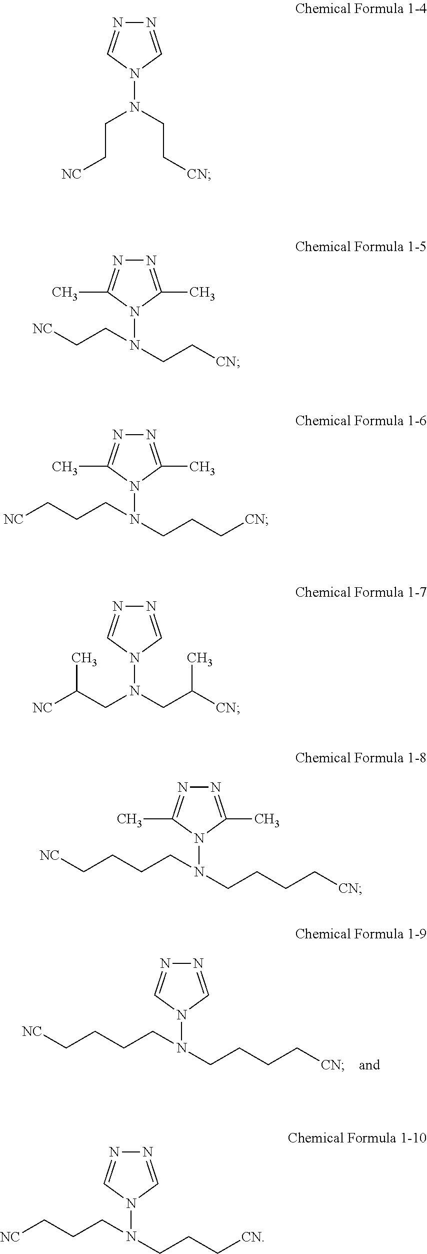

4. The positive electrode slurry of claim 1, wherein the compound of Chemical Formula 1 is included in an amount in a range of about 0.1 parts by weight to about 10 parts by weight based on 100 parts by weight of the positive electrode active material.

5. The positive electrode slurry of claim 1, wherein the positive electrode active material comprises a lithium nickel-based oxide having a nickel content of about 80 mol % or more based on 100 mol % of a metal other than lithium.

6. The positive electrode slurry of claim 1, wherein the positive electrode active material comprises a lithium nickel-based oxide and the lithium nickel-based oxide is represented by Chemical Formula 2: 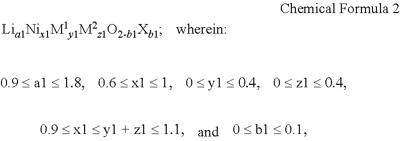
M¹ and M² each independently comprises one or more of Al, B, Ba, Ca, Ce, Co, Cr, Cu, Fe, Mg, Mn, Mo, Nb, Si, Sn, Sr, Ti, V, W, and Zr, and
X comprises one or more of F, P, and S.

7. The positive electrode slurry of claim 5, wherein the lithium nickel-based oxide is included in an amount of about 95 wt % or more of the positive electrode active material.

8. The positive electrode slurry of claim 1, wherein the binder comprises a fluorine-based binder.

9. The positive electrode slurry of claim 1, wherein the positive electrode slurry further comprises one or more conductive materials of carbon black and artificial graphite.

10. The positive electrode slurry of claim 9, comprising, based on a total of 100 parts by weight:
a range of about 90 parts by weight to about 99 parts by weight of the positive electrode active material;
a range of about 0.5 to about 5 parts by weight of the conductive material; and
a range of about 0.5 to about 5 parts by weight of the binder.

11. The positive electrode slurry of claim 1, further comprising a dispersion medium,
wherein the dispersion medium is included in an amount in a range of about 15 wt % to about 30 wt % of the positive electrode slurry, and
a solid content of the positive electrode slurry ranges from about 70 wt % to about 85 wt %.

12. A rechargeable lithium battery comprising:
a positive electrode; and
a negative electrode including a negative electrode active material,
wherein the positive electrode is manufactured with the positive electrode slurry of claim 1.

13. The rechargeable lithium battery of claim 12, wherein the negative electrode active material comprises at least one of graphite and a Si composite.

14. The rechargeable lithium battery of claim 12, wherein the rechargeable lithium battery is a cylindrical, prismatic, pouch-shaped, or coin-shaped battery.
